(19) United States
(12) Patent Application Publication
(10) Pub. No.: US 2005/0202803 A1
(43) Pub. Date: Sep. 15, 2005

(54) Secure interaction between downloaded application code and a smart card in a mobile communication apparatus

(75) Inventor: Ilan Mahalal, Paris (FR)

Correspondence Address: PEHR JANSSON, ATTORNEY AT LAW, 7628 PARKVIEW CIRCLE, AUSTIN, TX, 78731, US

(73) Assignee: Axalto SA, Montrouge (FR)

(21) Appl. No.: 10/514,582

(22) PCT Filed: May 28, 2003
(86) PCT No.: PCT/IB03/02247

§ 371 Date: Nov. 16, 2004

(30) Foreign Application Priority Data
May 30, 2002 (EP) 02077120.0
Oct. 4, 2002 (EP) 02292452.2

(51) Int. Cl. H04M 3/16

(52) U.S. Cl. 455/410

(57) ABSTRACT

Method for controlling the access to a security token (CAR) in a communication apparatus (MOB) by downloaded applications (DA) accessing the security token. The method includes a service-accessing step in which a downloaded application (DA) requests an access to the security token (CAR), a service-checking step in which a security token manager (STM), stored in the communication apparatus, checks the corresponding rights. The communication apparatus stores a plurality of security token interfaces (STI), and the Security Token Manager (STM) delivers the demanded Security Token Interface (STI) to the application (DA) if rights are satisfied or reject the demand.

### DESCRIPTION

1. Technical Field

The invention deals with download of applications in a communication apparatus coupled to a security token. The invention particularly applies to communication devices (such as mobile phone, PDA, etc.) coupled to a SIM (Subscriber Identity Module) card.

2. Prior Art

Many cryptographic tokens such as Integrated Circuit Cards (IC cards or ‘smart cards’) are intrinsically secure computing platforms ideally suited to providing enhanced security and privacy functionality to applications. They can handle authentication information such as digital certificates and capabilities, authorizations and cryptographic keys.

Furthermore, they are capable of providing secure storage and computational facilities for sensitive information such as:

Private keys and key fragments;

Account numbers and stored value;

Passwords and shared secrets;

Authorizations and permissions.

At the same time, many of these tokens provides an isolated processing facility capable of using this information without exposing it within the host environment where it is at potential risk from hostile code (viruses, Trojan horses, and so on). This becomes critically important for certain operations such as:

Generation of digital signatures, using private keys, for personal identification.

Network authentication based on shared secrets.

Maintenance of electronic representations of value.

Portable permissions for use in off-line situations.

New mobile phones are emerging which allow additional downloaded code to be installed in the phone. A concrete example is Java enabled mobile phone that can install new downloaded applets. This gives a versatile solution for adding new applications to the mobile phone. The user can select the applications that he needs and download them from a server. Examples of applications can be games, Calendar and meeting management, e-commerce enabler applications etc. Some of these applications may need to interact with the security token (SIM card or any other type of smart card or security token in the phone) in the mobile phone in order to benefit from its virtues as described above. This is especially important for downloaded applications that want to implement security related solutions and may need to access the smart card functions or store sensitive data in the card. Since downloaded code is not necessarily trusted the access to the smart card must be controlled and secure. Malicious applets may introduce security problems by using the smart card in a malicious way. Some of the possible attacks are described below:

Denial of service attacks (the Downloaded application can constantly send APDU (Application Protocol Data Unit) commands to the SIM)

PIN (Personal Identity Number) code stealing (a malicious Downloaded application may capture the user's PIN code and send it over the network and/or authenticates itself as the user). If the Downloaded application is then able to use this PIN code and send it to the card it can manage to do operations that normally can only be done upon user consent. An example is performing a non-repudiation digital signature with the smart card without user approval.

Gain read access to the user's private information on the card if a Downloaded application manages to get hold of the user's PIN code

Change data in the card if a Downloaded application manages to get hold of the user's PIN code

### SUMMARY OF THE INVENTION

Mobile phones (or equivalent mobile apparatus like PDAs) are emerging which allow the downloading of new applications code in the phone. So, the aim of the invention is to provide a solution by which there is an access control to the smart card and also associated mechanisms that guarantee a controlled and secure interaction.

According to the invention, when a downloaded application (DA) requests an access to the security token (CAR), a security token manager (STM), stored in the communication apparatus, checks corresponding rights attached to the downloaded application. Said communication apparatus stores a plurality of security token interfaces (STI); the Security Token Manager (STM) delivers the demanded Security Token Interface (STI) to the application (DA) if rights are satisfied. If rights are not satisfied, the security token manager rejects the access.

So that, we see that the access to the security token is controlled and is function of rights allocated to the downloaded application. The invention defines a controlled and secure access to the security token by which the newly downloaded applications can benefit from its functionality but at the same time cannot attack it or use it maliciously against the user or other parts that are involved in the application domain.

It will be easier to understand the invention on reading the description below, given as an example and referring to the attached drawings.

### IN THE DRAWINGS

FIG. 1 represents an example of a data processing system S in which the invention may be applied.

FIG. 2 illustrates a view of a communication apparatus coupled to a SIM card. This figure particularly shows a token manager, security token interface and a downloaded application.

FIGS. 2 and 3 illustrate the interactions between said token manager, the security token interface and the downloaded application.

### DETAILED DESCRIPTION OF EXAMPLES ILLUSTRATING THE INVENTION

To simplify the description, the same elements illustrated in the drawings have the same references.

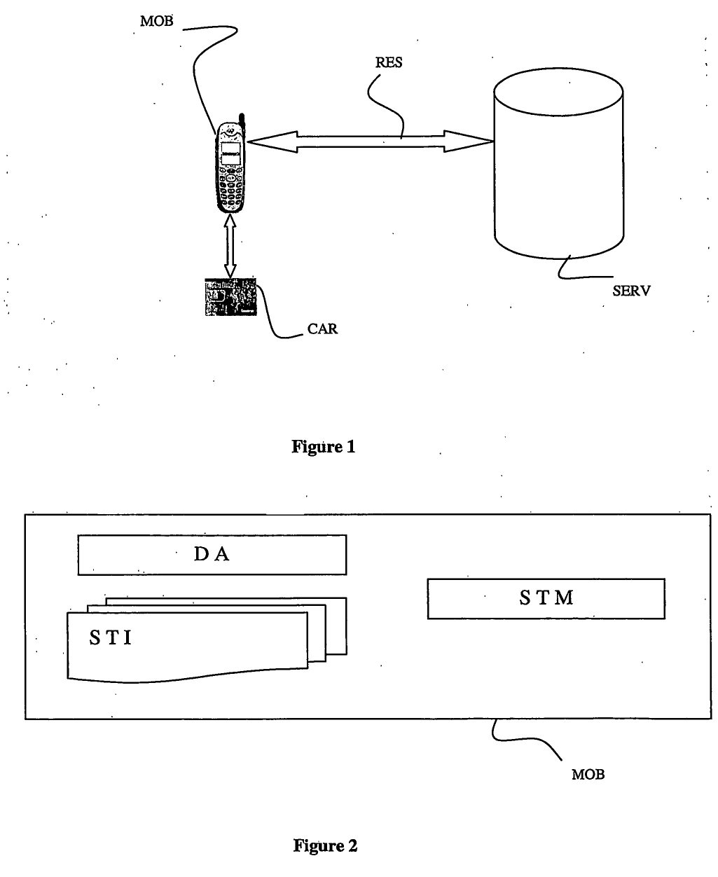

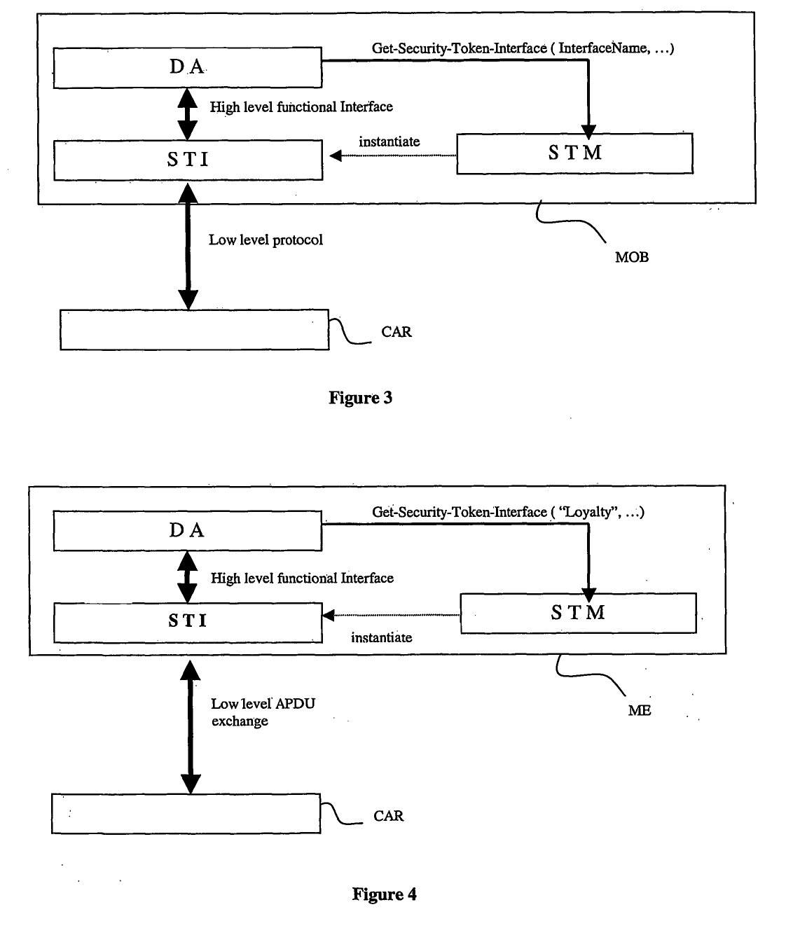

FIG. 1 represents a system S. In our example, this system includes a SIM card CAR coupled to a communication apparatus MOB communicating with a remote entity such as a server SERV through a network RES. In our illustrated example, the communication apparatus is a mobile phone MOB.

The SIM card can store applications. Application providers (or service provider) develop applications that can then be downloaded into the mobile phone. They also provide value added services, useful applications and/or games and entertainment in which the user may be interested. The user can download these applications from the server SERV and install them in the phone MOB.

A telecom operator provides the network infrastructure for the communication and application download. In our example, the network operator is also the owner of the smart card (e.g. SIM card) in the phone and wants to control the access to it by non-authorized parties (e.g. downloaded application code).

The card CAR also stores a Security Token Manager STM. This Security Token Manager STM is implemented in the communication apparatus MOB (e.g. mobile phone) operating system in order to implement the proposed solution. This security token manager controls the installation of security token interfaces STI in the communication apparatus MOB. Security Token Interfaces STI are programs that implement access to the security token and expose a limited and high-level functions for the downloaded applications in order to access the Security token functionalities. Several security token interfaces STI can be installed, each of which implement different kind of interfaces for different functionalities. Preferably, only the security token owner can install these security token interfaces. The security token manager STM installs the code for these interfaces only if it can verify that the security token interfaces code are signed by the security token owner. A digital signature using public key cryptography can be used for this purpose and the trusted certificate for verifying it may be retrieved from the Security Token itself.

A downloaded application that needs to communicate with the Security Token (e.g. smart card) will ask the Security Token Manager STM an interface object in order to communicate with the Security Token. The downloaded application will indicate the needed interface object name and then the Security Token Manager will need to check the downloaded application credentials in order to verify if it has the right to access this interface. The safest way to indicate a downloaded application credentials is to include it in its downloaded code with a digital signature that can be verified by the communication apparatus MOB (e.g. mobile phone) operating system. The Security Token Manager STM will retrieve the downloaded application credentials from the operating system and will then be able to deduce the access rights of the downloaded application.

Preferably, access control and usage of the security token in the phone (or other communication apparatus) should be defined and implemented by the security token owner. In the case of a SIM card in GSM phones, the security token owner is the Telecom operator, but in other business contexts it may be another entity.

The following scenario aims to illustrate the interactions between a downloaded application DA in a mobile phone MOB and the card CAR in the phone. In this example, the card CAR has an application that manages cumulated loyalty points.

This example illustrates the usage of the SIM card for providing a common secure portable data sharing media to several downloaded applications residing on the mobile phone MOB.

The user downloads and runs a variety of downloaded applications, games and online gaming or information services. As the downloaded applications DA are run, the user gains points e.g. Loyalty points. Instead of being stored within the downloaded applications these points are stored on the SIM card CAR and then used as a common access pool to other downloaded applications.

The card CAR stores the users private loyalty points and can select if these points are used to upgrade for newer levels (an update of the downloaded application can then take place or a request can be sent to allow the card CAR to authorize the next level) or further services. In addition, the points can be used to “pay” for additional network services such as ring-tones or additional airtime in pre-paid. The advantage of being on the card is that a user could transfer them to another mobile phone, which could contain the same suite of downloaded applications.

Several downloaded applications can share the same secure storage for loyalty points that is managed by a custom smart card application in the SIM card. A downloaded application that needs to update or read current loyalty points status asks the Security Token Manager STM for the Security Token Interface STI for example called “loyalty”.

The Security Token Manager STM will deliver this service object only if it can verify that the downloaded application DA is authorized to use it (e.g. has credentials with the right digital signature). The Security Token Interface STI object was downloaded before by the Telecom Operator or was retrieved directly from the smart card itself. In our example, the service provider that delivers the downloaded application has an agreement with the telecom operator to use this interface. As a result the downloaded application DA knows how to interact the interface high-level functions.

In this example the “loyalty” Security Token Interface object contains three functions:

A first function for example called “VerifyUserIdentity( )” for checking the user identity;

A second function for example called “IncrementPoints(number)” for incrementing points;

And a third function for example called “DecrementPoints(number)” for decrementing points.

In our example, when the downloaded application calls the VerifyUserIdentity function, the Security Token Interface object STI handles all the user interface interactions with the user in order to capture the user's PIN code and send it to the smart card application. In our embodiment, the user's PIN code is not delivered to the downloaded application for security reasons. The Security Token Interface object also selects the needed smart card application and formats all APDU commands (low level smart card commands) that need to be sent.

When the downloaded application DA calls the “IncrementPoints” function or the “DecrementPoints” function, the Security Token Interface object STI formats all the needed APDU commands that are needed to implement these functions, and send them to the smart card application.

Generally, the invention concerns a communication apparatus MOB comprising a microcontroller and being able to store applications DA downloaded from a remote entity, said communication apparatus being coupled to a security token CAR, characterized in that said communication apparatus comprises a security token manager STM which checks credentials of said downloaded application and, in function of these credentials, delivers a corresponding interface STI for interfacing said downloaded application DA and said security token CAR.

So that, the security token owner can, dynamically and also remotely, install a plurality of interfaces (one or more) in the communication apparatus. These interfaces, and only these interfaces, can be used by the downloaded applications in order to access the security token.

The invention also concerns the method for controlling the access to the security token CAR. The steps are:

i. A service-accessing step in which said downloaded application (DA) requests an access to the security token CAR,

ii. A service-checking step in which a security token manager STM, stored in said communication apparatus, checks the corresponding credentials,

iii. And a delivering step in which, in function of these credentials, said security token manager STM delivers a corresponding security token interface STI to the application DA if rights are satisfied; if not satisfied said security token manager rejects the access.

In step c), if the downloaded application DA has no rights, no Security Token Interface STI object is delivered.

We have seen that, preferably, the downloaded application DA is encrypted and/or signed, and in that for performing the service-checking step, the security token manager STM checks the corresponding rights by determining credentials using the corresponding encryption key or the digital signature.

We have also seen in our illustrated invention that each interface STI comprises high-level functions for the downloaded applications DA in order to access the Security Token CAR functionalities, and in that the interface STI formats all APDU commands (low level smart card commands) that need to be sent to the security token CAR.

Interfaces STI are preferably remotely installed in the communication apparatus MOB by the security token owner.

Preferably, the Security Token Manager STM installs the code for the interfaces in the communication apparatus MOB only if it can verify that the Security Token Interfaces STI code are signed by the Security Token Owner. Advantageously, a digital signature using public key cryptography is used and the trusted certificate for verifying it is retrieved from the Security Token CAR itself

The invention also concerns a computer program stored in the security token CAR. This computer program includes code instructions for checking credentials of application which has been downloaded in a communication apparatus (MOB) and, in function of these credentials, delivers a corresponding interface (STI) for interfacing a communication between said downloaded application and a security token (CAR).

We now see that this invention offers clear advantages. The described solution resolves the security issues that were expressed above. Another main advantage of this solution is the full control that the Security Token Owner has over the access interface which is accessible to downloaded applications. The Security Token Owner can remotely and dynamically add Security Token Interfaces or remove some of them. This solution open the door to some interesting business models for deploying security related services with downloaded applications.

1. Communication apparatus (MOB) comprising a microcontroller and being able to store applications (DA) downloaded from a remote entity, said communication apparatus being coupled to a security token (CAR), wherein said communication apparatus stores a security token manager (STM) which checks credentials of said downloaded application and, in function of these credentials, delivers a corresponding interface (STI) for interfacing said downloaded application (DA) and said security token (CAR).

2. A method for controlling the access to a security token (CAR) by applications (DA) downloaded in a communication apparatus (MOB) coupled to said security token, comprising:
a. A service-accessing step in which said downloaded application (DA) requests an access to the security token (CAR),
b. A service-checking step in which a security token manager (STM), stored in said communication apparatus, checks the credentials of said downloaded application,
c. And a delivering step in which, in function of these credentials, said security token manager (STM) delivers a corresponding security token interface (STI) to the application (DA) if rights are satisfied; if not satisfied said security token manager rejects the access.

3. The method according to claim 1, wherein the downloaded application (DA) is encrypted and/or signed, and in wherein for performing the service-checking step, the security token manager (STM) checks the corresponding rights by determining credentials using the corresponding encryption key and/or the digital signature.

4. The method according to claim 1, wherein each interface (STI) comprises high-level functions for the downloaded applications (DA) in order to access the Security Token (CAR) functionalities, and wherein the interface (STI) formats all APDU commands (low level smart card commands) that need to be sent from the communication apparatus to the security token (CAR).

5. The method according to claims 1, wherein said interfaces (STI) are remotely installed in the communication apparatus (MOB) by the security token owner.

6. The method according to claim 5, wherein the Security Token Manager (STM) installs the code for the interfaces in the communication apparatus (MOB) only if it can verify that the Security Token Interfaces code is signed by the Security Token Owner.

7. The method according to claim 3, wherein a signature using public key cryptography is used and the trusted certificate for verifying this signature is retrieved from the Security Token (CAR) itself.

8. The method according to claim 1, wherein in step c), if the downloaded application (DA) has no rights, then no Security Token Interface (STI) is delivered.

9. A security token (CAR) coupled to a communication apparatus (MOB) being able to store downloaded applications from a remote entity, comprising a computer program stored in the security token (CAR), said program including code instructions for checking credentials of application which has been downloaded in a communication apparatus (MOB) and, in function of these credentials, delivers a corresponding interface (STI) for interfacing a communication between said downloaded application and a security token (CAR).

10. The method according to claims 3, wherein said interfaces (STI) are remotely installed in the communication apparatus (MOB) by the security token owner.

11. The method according to claim 10, wherein the Security Token Manager (STM) installs the code for the interfaces in the communication apparatus (MOB) only if it can verify that the Security Token Interfaces code is signed by the Security Token Owner.

12. The method according to claim 10, wherein a signature using public key cryptography is used and the trusted certificate for verifying this signature is retrieved from the Security Token (CAR) itself.
